(19) United States
(12) Patent Application Publication
(10) Pub. No.: US 2011/0262162 A1
(43) Pub. Date: Oct. 27, 2011

(54) IMAGE FORMING METHOD ADJUSTING APPARATUS, IMAGE FORMING APPARATUS AND IMAGE FORMATION ADJUSTING METHOD

(75) Inventor: Keiji Yuge, Kanagawa (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/037,556

(22) Filed: Mar. 1, 2011

Related U.S. Application Data
(60) Provisional application No. 61/327,888, filed on Apr. 26, 2010.

(51) Int. Cl. G03G 15/16

(52) U.S. Cl. 399/66

(57) ABSTRACT

An image forming apparatus includes a recording medium supply device to supply a recording medium, an image forming part to form an image on the recording medium supplied by the recording medium supply device, a recording medium determination part that is disposed downstream of the recording medium supply device in a recording medium conveyance direction and upstream of the image forming part in the recording medium conveyance direction and includes a light-emitting device and a light-receiving device, and a control part to adjust an image forming method based on an output of the light-receiving device.

### CROSS-REFERENCE TO RELATED APPLICATION

This application is based upon and claims the benefit of priority from the prior the U.S. Patent Application No. 61/327,888, filed on Apr. 26, 2010, and the entire contents of which are incorporated herein by reference.

### FIELD

Embodiments described herein relate generally to an image forming method adjusting apparatus, an image forming apparatus and an image formation adjusting method.

### BACKGROUND

In an image forming apparatus such as a printer, in order to obtain a finer image, it is necessary to change an image forming method according to the type of a recording medium on which an image is formed.

In a related art image forming apparatus, the type of a recording medium is determined according to an instruction from an upper-level machine such as a personal computer or an instruction from a control panel of the image forming apparatus, and an image forming method is changed.

However, there is a case where an actually inputted recording medium is different from the instruction from the upper-level machine or the control panel due to an operator's error or the like. In such a case, an appropriate image is not formed.

Accordingly, an image forming method adjusting apparatus, an image forming apparatus and an image formation adjusting method are required in which an image forming method corresponding to the type of an actually inputted recording medium is accurately selected and is carried out.

### BRIEF DESCRIPTION OF THE DRAWINGS

FIG. 1 is a view showing a structure of an image forming apparatus.

FIG. 2 is a block diagram showing the structure of the image forming apparatus.

FIG. 3 is a view showing an image forming method of an electronic image forming apparatus based on transmitted light intensity.

FIG. 4 is a view showing an image forming method of an electronic image forming apparatus based on recording medium electric resistance.

FIG. 5 is a view showing an image forming method of an ink-jet image forming apparatus based on transmitted light intensity.

FIG. 6 is a view showing an image forming method of an ink-jet image forming apparatus based on recording medium electric resistance.

FIG. 7 is a flowchart showing an operation of an image forming apparatus.

### DETAILED DESCRIPTION

Throughout this description, the embodiments and examples shown should be considered as exemplars, rather than limitation on the apparatus and methods of the present embodiments.

Hereinafter, embodiments of an image forming method adjusting apparatus, an image forming apparatus and an image formation adjusting method will be described in detail with reference to the drawings. Here, the image forming apparatus includes a copying machine, an MFP (Multifunction Peripheral) and a printer.

According to an aspect of the invention, an image forming method adjusting apparatus includes a light-emitting device to emit light to a recording medium, a light-receiving device that is disposed to be opposite to the light-emitting device across a recording medium conveyance path, receives the irradiation light of the light-emitting device passing through the recording medium, and outputs an output corresponding to an intensity of the received transmitted light, and a control part to adjust an image forming method based on the output of the light-receiving device.

According to another aspect of the invention, an image forming apparatus includes a recording medium supply device to supply a recording medium, an image forming part to form an image on the recording medium supplied by the recording medium supply device, a light-emitting device to emit light to the recording medium, a light-receiving device that is disposed to be opposite to the light-emitting device across a recording medium conveyance path, receives the irradiation light of the light-emitting device passing through the recording medium, and outputs an output corresponding to an intensity of the received transmitted light, and a control part to adjust an image forming method based on the output of the light-receiving device.

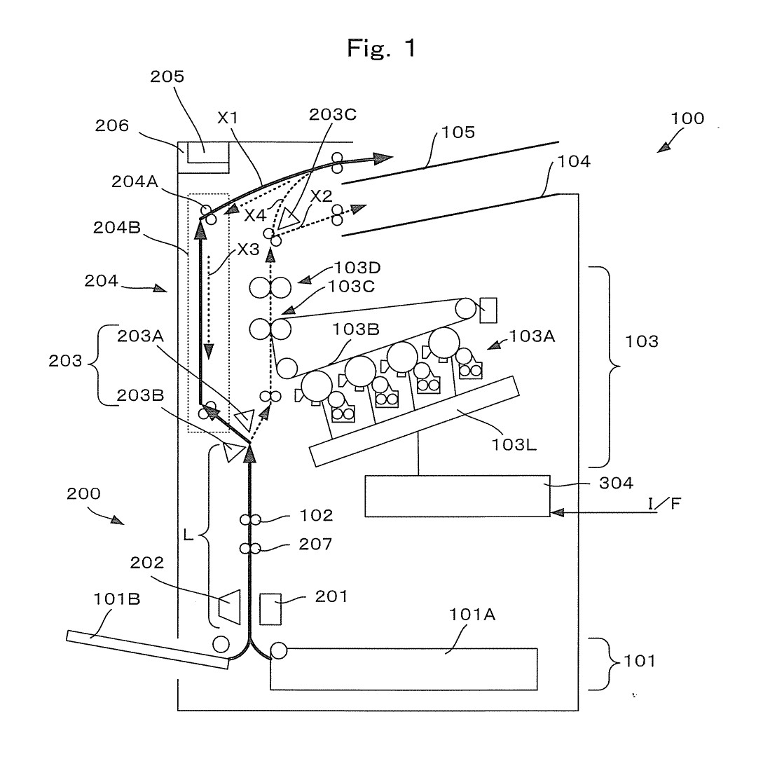

FIG. 1 is a view showing a structure of an image forming apparatus 100 of an embodiment. As shown in FIG. 1, the image forming apparatus 100 includes a recording medium supply device 101 to supply a recording medium, an image forming part 103 to form an image on the recording medium supplied by the recording medium supply device 101, a recording medium determination part 200 that is disposed downstream of the recording medium supply device 101 in a recording medium conveyance direction and upstream of the image forming part 103 in the recording medium conveyance direction and includes a light-emitting device 201 and a light-receiving device 202, and a control part to adjust an image forming method based on the output of the light-receiving device 202.

Besides, the image forming apparatus 100 further includes a resistance sensor 207 that is disposed downstream of the recording medium supply device 101 in the recording medium conveyance direction and upstream of the image forming part 103 in the recording medium conveyance direction and detects an electric resistance of the recording medium. The control part can also adjust the image forming method based on the output of the resistance sensor 207 and the output of the light-receiving device 202.

The resistance sensor 207 detects the electric resistance of the recording medium by applying a current from one side of the recording medium to the other side of the recording medium in a state where the recording medium is sandwiched. The resistance sensor 207 is provided in a constant current output circuit and detects a generated voltage.

As the recording medium supply device 101, for example, a recording medium supply cassette 101A or a manual feed recording medium supply device 101B can be adopted. The recording medium supply device 101 picks up the recording medium by a pickup roller and delivers it to a recording medium conveyance device 102.

The light-emitting device 201 and the light-receiving device 202 are disposed at both sides of the recording medium conveyance path and are opposite to each other. The light-emitting device 201 emits light to the recording medium. When the recording medium is conveyed, the light-receiving device 202 receives the light of the light-emitting device 201 passing through the recording medium, converts the received light into an electronic signal and outputs it to the control part.

The recording medium conveyance device 102 conveys the recording medium to the image forming part 103. The image forming part 103 may be an electronic image forming part or an ink-jet image forming part.

In the case of the electronic image forming part, the image forming part 103 includes an electrostatic latent image forming part 103A. The electrostatic latent image forming part 103A includes a laser light irradiation device 103L to irradiate laser light based on an instruction of an image processing part 304, a photoconductive drum as an electrostatic latent image carrier that carries an electrostatic latent image by being applied with a voltage and irradiated with the laser light, and a developer supply device to supply a developer to the electrostatic latent image carrier.

A developer is supplied to the electrostatic latent image on the electrostatic latent image carrier and a developer image is formed.

In the case of the image forming apparatus for performing color printing, the electrostatic latent image forming part 103A is provided for each color of yellow, magenta, cyan and black.

The image forming part 103 includes a transfer belt 103B to which the developer image is transferred and which carries the developer image, a transfer device 103C to transfer the developer image on the transfer belt 103B to the recording medium, and a fixing device 103D to heat and press the developer image on the recording medium and to fix it to the recording medium.

The transfer device 103C changes a transfer voltage based on an instruction of the control part. When the transfer voltage is high, a larger amount of developer is transferred to the recording medium, and when the transfer voltage is low, a smaller amount of developer is transferred to the recording medium.

In the case of the ink-jet image forming part, the image forming part 103 includes an ink supply device and an ink-jet head to discharge supplied ink.

In the ink-jet head, piezoelectric elements with different polarities are bonded to each other, and the piezoelectric elements are arranged in a comb tooth shape. Each of the piezoelectric elements is provided with an electrode. Further, a sealing having a discharge port for discharging the ink is arranged at the upper end of the piezoelectric elements.

Voltage is applied to the piezoelectric element by the electrode. When the voltage is applied, the piezoelectric element is deformed, sucks the ink by the deformation, and discharges it from the discharge port to the recording medium.

Shading is produced on the formed image according to the intensity of the applied voltage, the application duty and the feed speed of the recording medium.

The image forming apparatus 100 may include a double-sided printing mechanism 204. The double-sided printing mechanism 204 includes a switch back tray 105 to switch back the recording medium passing through the image forming part 103, and a switch back conveyance mechanism 204A to again convey the switched back recording medium to the image forming part 103.

The recording medium having a surface on which an image is to be formed is guided to the image forming part 103 by a first switching device 203A. The recording medium on which the image is formed by the image forming part 103 is guided to the switch back tray 105 as indicated by a dotted arrow X4, and is next guided by the switch back conveyance mechanism 204A to a sub-conveyance path 2048 as indicated by a dotted arrow X3, that is, the trailing edge of the recording medium becomes the leading edge.

The recording medium is again conveyed to the image forming part 103 by a second switching device 203B and the first switching device 203A, and an image is formed on the back surface. The recording medium subjected to the double-sided image formation is discharged to a paper discharge tray 104.

Hereinafter, the first switching device 203A and the second switching device 203B are collectively called a switching device 203.

A distance L between the light-receiving device 202 and the second switching device 203B is longer than the maximum length of the conveyed recording medium.

The light-emitting device 201 may be an image sensor to read an image on a recording medium. As the image sensor, a color or monochrome line sensor, a CMOS sensor or the like can be used.

When the light-emitting device 201 is the image sensor, the image forming apparatus 100 determines based on the output of the image sensor whether an image is already formed on a surface on which an image is to be formed.

When it is determined based on the output of the image sensor that the image is already formed on the image forming surface of the recording medium, the control part changes a conveyance method of the recording medium to a conveyance method different from a conveyance method for a case where image formation is performed.

When determining that an image is already formed on the surface to be subjected to image formation, the image forming apparatus 100 allows the recording medium to be discharged to the outside of the apparatus by the double-sided printing mechanism 204 as indicated by a black arrow X1 without passing through the image forming part 103.

Incidentally, when determining that an image is already formed on the surface to be subjected to image formation, the image forming apparatus 100 may allow the recording medium to be discharged to the recording medium supply device 101 without passing through the image forming part 103. The recording medium supply device 101 of the discharge destination in this case may be different from the recording medium supply device 101 of the recording medium supply source.

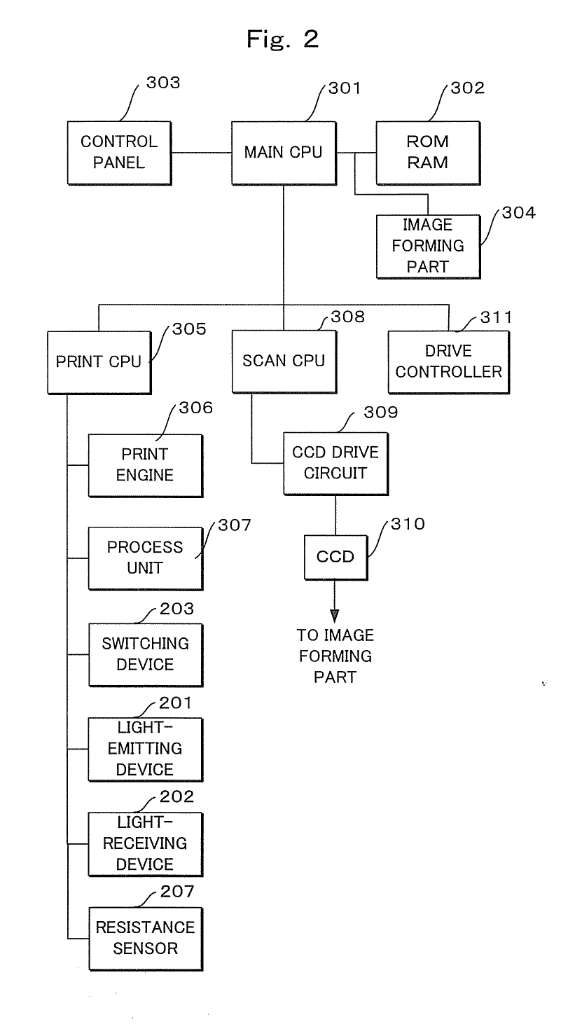

FIG. 2 is a block diagram showing a structure of the image forming apparatus 100. As shown in FIG. 2, the image forming apparatus 100 includes a main CPU 301 as a control part, a control panel 303 as an input and output display device, a ROM and RAM 302 as a storage device, an image processing part 304 to perform image processing and to output a signal for image formation, a print CPU 305, a scan CPU 308, and a drive controller 311 to control the conveyance device.

The print CPU 305 is connected to a print engine 306, a process unit 307, the switching device 203 and the light-emitting device 201 and controls them.

The print CPU 305 is connected to the light-receiving device 202 and the resistance sensor 207, and inputs signals from these devices.

The scan CPU 308 controls a CCD (Charge Coupled Device) drive circuit 309. The CCD drive circuit 309 drives a CCD 310, and outputs an output of the CCD 310 to the image forming part 103.

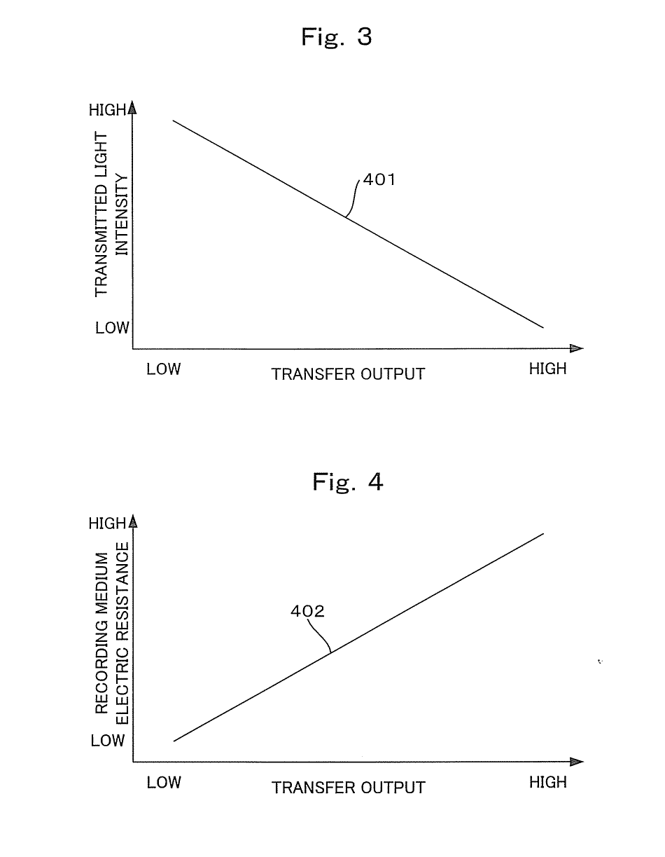

FIG. 3 is a view showing an image forming method based on transmitted light intensity by the electronic image forming apparatus 100. The vertical axis indicates the intensity of transmitted light received by the light-receiving device 202, and the horizontal axis indicates transfer output.

As shown by a graph 401 of FIG. 3, the image forming apparatus 100 changes the transfer output of the transfer device 103C, that is, the transfer voltage based on the intensity of the transmitted light received by the light-receiving device 202.

Specifically, the image forming device 100 reads a default transfer output, that is, a transfer voltage and a reference transmitted light intensity from the storage device.

When the intensity of the received transmitted light is higher than the reference transmitted light intensity, the image forming apparatus 100 controls to decrease the transfer output. On the contrary, when the intensity of the received transmitted light is lower than the reference transmitted light intensity, the image forming apparatus 100 controls to increase the transfer output.

That is, the image forming apparatus 100 controls such that as the intensity of the transmitted light becomes high, the transfer output becomes low, and as the intensity of the transmitted light becomes low, the transfer output becomes high.

FIG. 4 is a view showing an image forming method based on recording medium electric resistance by the electronic image forming apparatus 100. The vertical axis indicates the recording medium electric resistance detected by the resistance sensor 207, and the vertical axis indicates the transfer output.

As shown by a graph 402 of FIG. 4, the image forming apparatus 100 changes the transfer output of the transfer device 103C, that is, the transfer voltage based on the output of the resistance sensor 207.

Specifically, the image forming apparatus 100 reads a default transfer output, that is, a transfer voltage and a reference recording medium electric resistance from the storage device.

The image forming apparatus 100 controls to increase the transfer output when the detected recording medium electric resistance is larger than the reference recording medium electric resistance. On the contrary, the image forming apparatus 100 controls to decrease the transfer output when the detected recording medium electric resistance is lower than the reference recording medium electric resistance.

That is, the image forming apparatus 100 controls such that as the recording medium electric resistance becomes low, the transfer output becomes low, and as the recording medium electric resistance becomes high, the transfer output becomes high.

This control is performed in order to be able to treat a recording medium, such as an OHP sheet, which has high transmitted light intensity and requires high transfer output.

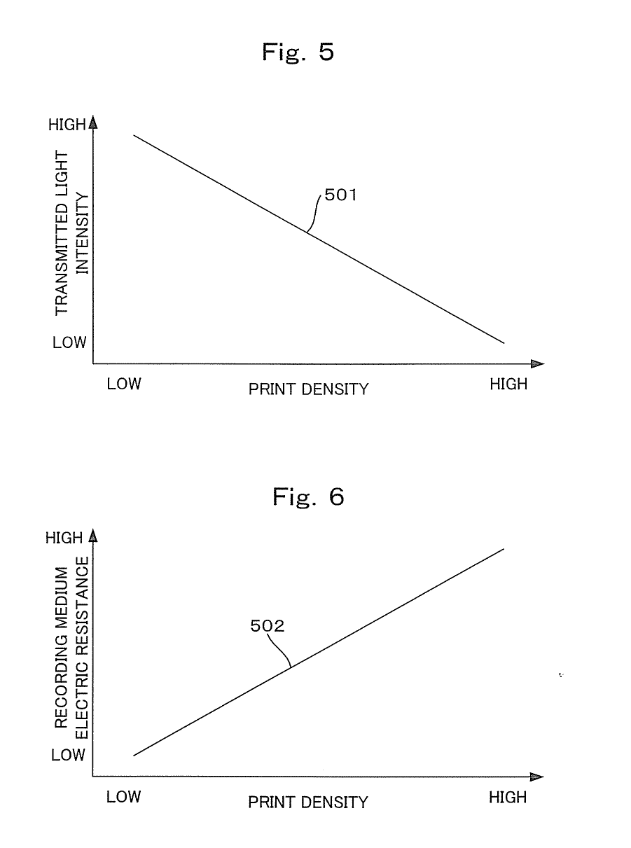

FIG. 5 is a view showing an image forming method based on a transmitted light intensity by the ink-jet image forming apparatus 100. The vertical axis indicates the intensity of transmitted light received by the light-receiving device 202, and the horizontal axis indicates print density.

As shown by a graph 501 of FIG. 5, the image forming apparatus 100 changes the print density based on the intensity of the transmitted light received by the light-receiving device 202.

Specifically, the image forming apparatus 100 reads a default print density and a reference transmitted light intensity from the storage device.

The image forming apparatus 100 controls to decrease the print density when the intensity of the received transmitted light is higher than the reference transmitted light intensity. On the contrary, the image forming apparatus 100 controls to increase the print density when the intensity of the received transmitted light is lower than the reference transmitted light intensity.

That is, the image forming apparatus 100 controls such that as the transmitted light intensity becomes high, the print density becomes low, and as the transmitted light intensity becomes low, the print density becomes high.

FIG. 6 is a view showing an image forming method based on recording medium electric resistance by the ink-jet image forming apparatus 100. The vertical axis indicates the recording medium electric resistance detected by the resistance sensor 207, and the horizontal axis indicates the print density.

As shown by a graph 502 of FIG. 6, the image forming apparatus 100 changes the print density based on the output of the resistance sensor 207.

Specifically, the image forming apparatus 100 reads a default print density and a reference recording medium electric resistance from the storage device.

The image forming apparatus 100 controls to increase the print density when the detected recording medium electric resistance is higher than the reference recording medium electric resistance. On the contrary, the image forming apparatus 100 controls to decrease the print density when the detected recording medium electric resistance is lower than the reference recording medium electric resistance.

That is, the image forming apparatus 100 controls such that as the recording medium electric resistance becomes low, the print density becomes low, and as the recording medium electric resistance becomes high, the print density becomes high.

This control is performed in order to able to treat a recording medium, such as an OHP sheet, which has high transmitted light intensity and requires high print density.

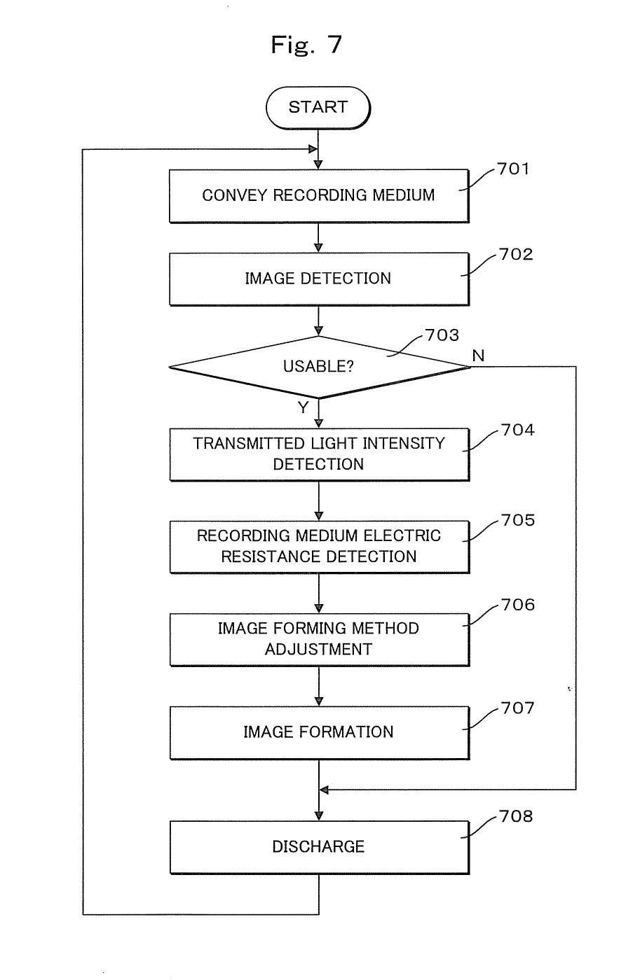

FIG. 7 is a flowchart showing an operation of the image forming apparatus 100. As shown in FIG. 7, at ACT 701, the image forming apparatus 100 conveys a recording medium from the recording medium supply device 101.

At ACT 702, when the light-emitting device 201 is an image sensor, the image forming apparatus 100 detects an image by the image sensor.

At ACT 703, based on whether an image is already formed on an image forming surface, the image forming apparatus 100 determines whether the recording medium can be used. When the image forming apparatus 100 determines that the recording medium can not be used, advance is made to ACT 708, and when determines that the recording medium can be used, advance is made to ACT 704.

At ACT 704, the image forming apparatus 100 detects the intensity of transmitted light passing through the recording medium based on the output of the light-receiving device 202.

At ACT 705, the image forming apparatus 100 detects the recording medium electric resistance based on the output of the resistance sensor 207.

At ACT 706, the image forming apparatus 100 adjusts the image forming method based on the transmitted light intensity or the recording medium electric resistance. In the case of the electronic image forming apparatus, the transfer voltage intensity is adjusted. In the case of the ink-jet image forming apparatus, the print density is adjusted.

At ACT 707, the image forming apparatus 100 forms an image on the recording medium. At ACT 708, the image forming apparatus 100 discharges the recording medium subjected to the image formation to the outside of the apparatus.

As described above, the image forming apparatus 100 of this embodiment includes the recording medium supply device 101 to supply a recording medium, the image forming part 103 to form an image on the recording medium supplied by the recording medium supply device 101, the recording medium determination part 200 that is disposed downstream of the recording medium supply device 101 in the recording medium conveyance direction and upstream of the image forming part 103 in the recording medium conveyance direction and includes the light-emitting device 201 and the light-receiving device 202, and the control part to adjust the image forming method based on the output of the light-receiving device 202.

Accordingly, there is an effect that the image forming method corresponding to the type of an actually inputted recording medium can be accurately selected and can be carried out.

While certain embodiments have been described, these embodiments have been presented by way of example only, and are not intended to limit the scope of the inventions. Indeed, the novel methods and apparatuses described herein may be embodied in a variety of other forms; furthermore, various omissions, substitutions and changes in the form of the methods and systems described herein may be made without departing from the spirit of the inventions. The accompanying claims and their equivalents are indeed to cover such forms or modifications as would fall within the scope and spirit of the inventions.

What is claimed is:

1. An image forming method adjusting apparatus comprising:
a light-emitting device to emit light to a recording medium;
a light-receiving device that is disposed to be opposite to the light-emitting device across a recording medium conveyance path, receives the irradiation light of the light-emitting device passing through the recording medium, and outputs an output corresponding to an intensity of the received transmitted light; and
a control part to adjust an image forming method based on the output of the light-receiving device.

2. The apparatus of claim 1, wherein the control part controls to decrease a transfer output when the transmitted light intensity is high and to increase the transfer output when the transmitted light intensity is low.

3. The apparatus of claim 1, wherein the control part controls to decrease a print density when the transmitted light intensity is high and to increase the print density when the transmitted light intensity is low.

4. The apparatus of claim 2, further comprising a resistance sensor that sandwiches the recording medium and detects a recording medium electric resistance by applying a current from one surface of the recording medium to the other surface of the recording medium, wherein
the control part controls to decrease the transfer output when the recording medium electric resistance is low and to increase the transfer output when the recording medium electric resistance is high.

5. The apparatus of claim 3, further comprising a resistance sensor that sandwiches the recording medium and detects a recording medium electric resistance by applying a current from one surface of the recording medium to the other surface of the recording medium, wherein
the control part controls to decrease the print density when the recording medium electric resistance is low and to increase the print density when the recording medium electric resistance is high.

6. An image forming apparatus, comprising:
a recording medium supply device to supply a recording medium;
an image forming part to form an image on the recording medium supplied by the recording medium supply device;
a light-emitting device to emit light to the recording medium;
a light-receiving device that is disposed to be opposite to the light-emitting device across a recording medium conveyance path, receives the irradiation light of the light-emitting device passing through the recording medium, and outputs an output corresponding to an intensity of the received transmitted light; and
a control part to adjust an image forming method based on the output of the light-receiving device.

7. The apparatus of claim 6, wherein the light-receiving device is disposed downstream of the recording medium supply device in a recording medium conveyance direction and upstream of the image forming part in the recording medium conveyance direction.

8. The apparatus of claim 7, wherein the control part controls to decrease a transfer output when the transmitted light intensity is high and to increase the transfer output when the transmitted light intensity is low.

9. The apparatus of claim 7, wherein the control part controls to decrease a print density when the transmitted light intensity is high and to increase the print density when the transmitted light intensity is low.

10. The apparatus of claim 8, further comprising a resistance sensor that sandwiches the recording medium and detects a recording medium electric resistance by applying a current from one surface of the recording medium to the other surface of the recording medium, wherein
the control part controls to decrease the transfer output when the recording medium electric resistance is low and to increase the transfer output when the recording medium electric resistance is high.

11. The apparatus of claim 9, further comprising a resistance sensor that sandwiches the recording medium and detects a recording medium electric resistance by applying a current from one surface of the recording medium to the other surface of the recording medium, wherein
the control part controls to decrease the print density when the recording medium electric resistance is low and to increase the print density when the recording medium electric resistance is high.

12. The apparatus of claim 10, wherein the light-emitting device is an image sensor.

13. The apparatus of claim 11, wherein the light-emitting device is an image sensor.

14. The apparatus of claim 12, wherein when the control part determines based on an output of the image sensor that an image is already formed on an image forming surface of the recording medium, the control part discharges the recording medium to outside of the apparatus.

15. The apparatus of claim 13, wherein when the control part determines based on an output of the image sensor that an image is already formed on an image forming surface of the recording medium, the control part discharges the recording medium to outside of the apparatus.

16. An image formation adjusting method of an image forming apparatus, comprising:
irradiating light from a light-emitting device to a recording medium before an image is formed;
converting transmitted light of the light passing through the recording medium into an electronic signal by a light-receiving device and outputting it; and
adjusting an image forming method for the recording medium based on the output.

17. The method of claim 16, further comprising:
controlling to decrease a transfer output when an intensity of the transmitted light is high and to increase the transfer output when the intensity of the transmitted light is low.

18. The method of claim 17, further comprising:
detecting a recording medium electric resistance of the recording medium before an image is formed; and
controlling to decrease the transfer output when the recording medium electric resistance is low and to increase the transfer output when the recording medium electric resistance is high.
